(19) United States
(12) Patent Application Publication
(10) Pub. No.: US 2008/0097013 A1
(43) Pub. Date: Apr. 24, 2008

(54) Pigmented ink composition

(75) Inventor: Takuo Mizutani, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/898,346

(22) Filed: Sep. 11, 2007

(30) Foreign Application Priority Data
Oct. 19, 2006 (JP) 2006-284670

(51) Int. Cl. C08K 5/15

(52) U.S. Cl. 524/107

(57) ABSTRACT

An oil-based pigmented ink composition containing a pigment, a polymer and an organic solvent, in which the organic solvent contains 20 to 85% by weight of an ester derivative of mono- or polyethylene glycol having a flash point of 50 to 120° C. and a boiling point of 150 to 250° C., 5 to 50% by weight of a mono- or polyalkylene glycol dialkyl ether and 1 to 30% by weight of an oxygen-containing heterocyclic compound, each based on the whole weight of the ink composition.

### FIELD OF THE INVENTION

The present invention relates to an oil-based pigmented ink composition comprising a pigment, a polymer and an organic solvent, in particular, an oil-based pigmented ink composition for ink-jet printing systems.

### BACKGROUND ART

In an ink-jet printing system, a liquid ink is ejected from a nozzle of an ink-jet printer towards a recording medium using a pressure, heat or an electric field as a driving source to print characters, images, etc. on the recording medium. The ink-jet printing system can be used with a low running cost and form high quality images. Furthermore, this printing system can use various inks such as aqueous and oil-based inks. Accordingly, the ink-jet printing system has been expanding its market.

Under such circumstances, large-size ink jet printers, which can be used to print a sheet of the A-0 size with aqueous pigmented inks, have been developed, and are used to output indoor posters, CAD (computer aided drawing) drawings, or proofing for color matching in printing. The printed materials can be used outdoors with laminating a transparent film on their printed surface.

Furthermore, the demand for outdoor use of the ink-jet printed materials has been increased. Therefore, oil-based pigmented inks are developed, which can be printed directly on films of polyvinyl chloride (PVC) and used outdoors without lamination, and have good water resistance and weather resistance.

Since the oil-based pigmented inks comprise organic solvents as solvents unlike aqueous pigmented inks, they do not cause the cockling of a paper sheet in comparison with aqueous pigmented inks, or require no lamination of a film having a receptive layer after printing. Therefore, they can be printed on a substrate at low cost.

For example, an oil-based pigmented ink comprising a glycol solvent and a specific polyester resin is proposed (JP-A-10-077432, in particular, pages 2 to 5). However, since this oil-based pigmented ink does not contain a solvent in which polyvinyl chloride dissolves, it has low drying and fixing properties when it is printed on a film of, for example, PVC.

A pigmented ink comprising a glycol ether derivative and a specific nitrogen-containing heterocyclic compound as solvents is proposed (WO 04/007626, in particular, pages 3 and 4). However, when the glycol ether derivative is used as a primary solvent, the solubility of a resin in the mixed solvent is insufficient so that it is difficult to maintain the dispersion stability of the resin, the storage stability of the ink is inferior, and the ejection of the ink from a nozzle of an ink-Jet printer may become unstable.

Also, an oil-based pigmented ink comprising a specific glycol derivative and a nitrogen-containing heterocyclic compound as solvents is proposed (JP-A-2005-60716, in particular, pages 2 and 3). However, when a solvent having a particularly high resin-dissolvability such as a nitrogen-containing heterocyclic compound is used in combination with other solvent, a resin adsorbed on pigment particles is desorbed so that the pigment particles tend to agglomerate during the long-term storage of the ink.

Further, an oil-based pigmented ink comprising an ester derivative of propylene glycol and a heterocyclic compound is proposed (JP-A-2005-330298, in particular, pages 2 and 3). However, when the ester derivative of propylene glycol having a high flash point is used as a primary solvent of the ink, the drying property of the ink tends to decrease and thus blurring or off setting may occur. In addition, since the solubility of a resin in such a solvent is low, the dispersibility of the resin in the solvent is poor so that the long-term storage stability of the ink may be insufficient.

### SUMMARY OF THE INVENTION

In view of the above circumstances, an object of the present invention is to provide an oil-based pigmented ink, which achieves good drying properties of printed materials and a long-term storage stability that are important for an ink composition containing an organic solvent, can be printed on an expensive printing medium such as a PVC film having no receptive layer, and can endure outdoor environment.

To achieve the above object, an extensive study has been made. As a result, it has been found that when a specific mono- or polyethylene glycol derivative (hereinafter collectively referred to as “(poly)ethylene glycol derivative”) and an oxygen-containing heterocyclic compound are used in combination as the organic solvents of an oil-based pigmented ink composition, the ink composition has high safeness and low odor, can be printed on an inexpensive printing medium such as a PVC film having no receptive layer, and can satisfactorily endure outdoor environment, and in particular, the ink composition is suitable for ink-jet printing systems, and the present invention has been completed.

Accordingly, the present invention provides an oil-based pigmented ink composition comprising a pigment, a polymer and an organic solvent, wherein the organic solvent contains 20 to 85% by weight of an ester derivative of (poly) ethylene glycol having a flash point of 50 to 120° C. and a boiling point of 150 to 250° C., 5 to 50% by weight of a mono- or polyalkylene glycol dialkyl ether (hereinafter collectively referred to as “(poly)alkylene glycol dialkyl ether”) and 1 to 30% by weight of an oxygen-containing heterocyclic compound, each based on the whole weight of the ink composition.

Since the oil-based pigmented ink composition of the present invention contains the specific ester derivative of (poly)ethylene glycol and the oxygen-containing heterocyclic compound in combination as the organic solvents, the safety and odor, which are the problems of the conventional oil-based pigmented ink compositions, can be improved, and the ink composition can be printed with good fixing and drying properties on a film of PVC having no receptive layer. Furthermore, the ink composition of the present invention can form a printed material having good resistance to water and alcohol. In particular, the ink composition of the present invention is suitable for ink-jet printing systems.

### DETAILED DESCRIPTION OF THE INVENTION

The ester derivative of (poly)ethylene glycol which is used as one of the organic solvents according to the present invention has good dissolvability of resins and also good wettability to pigments and pigment-dispersibility since the ester derivative has an ester group in the molecule. Therefore, when the ester derivative of (poly)ethylene glycol is compounded as an ink solvent in the ink composition, it can impart stable ejection properties to the ink composition. Furthermore, the ester derivative of (polyethylene glycol has relatively low toxicity and odor and thus the ink composition comprising such an ester derivative can be easily handled.

Examples of the ester derivative of (poly) ethylene glycol include (poly) ethylene glycol monoalkyl ether monoalkyl esters, (poly) ethylene glycol dialkyl esters, and so on. When they are used as the solvents of the ink composition, not only the solubility and dispersibility of the resins therein but also the viscosity and drying property of the ink composition can be easily controlled. The alkyl group has the arbitrary number of carbon atoms as long as the ester derivative of (poly)ethylene glycol maintains a liquid state.

Examples of the (poly)ethylene glycol monoalkyl ether monoalkyl esters include ethylene glycol monoalkyl ether monoalkyl esters, diethylene glycol monoalkyl ether monoalkyl esters, triethylene glycol monoalkyl ether monoalkyl esters, and so on. Among these esters, the mono- or diethylene glycol monoalkyl ether monoalkyl esters are preferable, since the most of them has good dissolvability of the resins and a low viscosity in comparison with the triethylene glycol monoalkyl ether monoalkyl esters.

The specific examples of the above compounds include ethylene glycol monoethyl ether monomethyl ester, ethylene glycol monobutyl ether monomethyl ester, diethylene glycol monomethyl ether monomethyl ester, diethylene glycol monoethyl ether monomethyl ester, diethylene glycol monobutyl ether monomethyl ester, etc. Since these compounds have a moderate molecular weight, they have the safeness and prevent the clogging of nozzles due to the drying of the ink composition at the same time. They have no unpleasant odor and therefore the ink composition comprising such solvents may easily suppress unpleasant odor.

Examples of the dialkyl esters of (poly)ethylene glycol include ethylene glycol dialkyl esters, diethylene glycol dialkyl esters, triethylene glycol dialkyl esters, and so on. Among these diesters, ethylene glycol dimethyl ester, diethylene glycol dimethyl ester, and the like are preferably used since they have low odor.

The ester derivatives of (poly)ethylene glycols may be used singly or as a mixture of two or more of them. The amount of the ester derivative of (poly)ethylene glycol is from 20 to 85 by weight, preferably from 40 to 80% by weight, based on the whole weight of the ink composition.

When the amount of the ester derivative of (poly) ethylene glycol is less than 20% by weight, the dispersibility of the pigments may not be maintained so that the storage stability of the ink composition tends to be deteriorated. When the amount of the ester derivative of (polyethylene glycol exceeds 85% by weight, the drying of the ink which is printed may be slowed.

The ester derivative of (poly) ethylene glycol preferably has a flash point of 50 to 120° C., in particular 60 to 100° C., and a boiling point of 150 to 250° C., from the viewpoint of the drying property and odor of the ink composition.

In addition to the ester derivative of (poly)ethylene glycol, the ink composition of the present invention contains an oxygen-containing heterocyclic compound as an additional solvent for the purpose of fixing the pigments on a PVC film as a substrate by dissolving PVC.

Solvents in which PVC dissolves are known and examples thereof include ketones (e.g. acetone, methyl ethyl ketone, cyclohexanone, etc.), oxygen-containing heterocyclic compounds (e.g. tetrahydrofuran, tetrahydropyrane, etc.), nitrogen-containing heterocyclic compounds (e.g. pyrrolidone derivatives, etc.), and so on.

Among them, the ketones and tetrahydrofuran have good PVC-dissolving power. However, acetone, methyl ethyl ketone, methyl isobutyl ketone, methyl n-butyl ketone, cyclohexanone, methylcyclohexanone, tetrahydrofuran, etc. have strong odor, and they are designated in the Industrial Safety and Health Law. An ink composition containing 5% by weight or more of one of them based on the whole ink composition can be handled only by a person having a special qualification, and a person who handles such a material should get a medical checkup. Therefore, the handling of those solvents is troublesome.

Among the ketones and tetrahydrofuran derivatives other than the above compounds, ketones and tetrahydrofuran derivatives having a low molecular weight may well dissolve PVC, but many of them have a low flash point so that it is highly possible that ink compositions comprising such solvents have a flash point of lower than 61° C. and thus the transportation or storage of such an ink composition may sometimes regulated. Furthermore, since such solvents have strong odor, the ink composition containing only a slight amount of the solvent may emit odors. Ketones and tetrahydrofuran derivatives having a high molecular weight have a high flash point and low odor. However, such solvents less dissolve PVC and thus the ink composition may not be sufficiently fixed to the substrate.

When a tetrahydrofuran derivative or a tetrahydropyrane derivative is used as an ink solvent, sufficient attention should paid on the flashing point, boiling point and odor of the compound so that the characteristics of the ink composition are not deteriorated. Some of the tetrahydrofuran derivative or tetrahydropyrane derivative may be used as an ink solvent by increasing the boiling and flashing points thereof by replacing a substituent thereof.

The nitrogen-containing heterocyclic compounds such as pyrrolidone derivatives are heterocyclic compounds having at least one nitrogen atom as a constituent atom, and most of them do not violate the regulations of the industrial Safety and Health Law and are highly safe. However, they have a very high resin-dissolving power so that they interfere with the adsorption or the resin to the pigment particles to cause re-agglomeration of the resin particles. Accordingly, it is difficult to maintain the dispersion stability of the ink composition for a long time.

Among the oxygen-containing heterocyclic compounds, many compounds having a lactone structure such as 2-acetylbutyrolactone, γ-butyrolactone, δ-lactone, caprolactone, etc. have less odor and high safety and thus are preferably used as ink solvents. In addition, they hardly cause the re-agglomeration of the pigment particles and can maintain the dispersion stability of the ink composition for a long time, although they have good dissolving property of the resins.

According to the present invention, compounds having a high flashing point, low odor and good PVC dissolving properties are selected from the oxygen-containing heterocyclic compounds such as those having the lactone structure. Thereby, the fixing property of the ink composition can be increased.

The amount of the oxygen-containing heterocyclic compound to be used is from 1 to 30% by weight, preferably from 10 to 30% by weight, more preferably from 20 to 30% by weight, based on the whole weight of the ink composition. When the amount of the oxygen-containing heterocyclic compound is less than 1% by weight, the PVC-dissolving property is insufficient. When the amount of the oxygen-containing heterocyclic compound exceeds 30% by weight, the PVC-dissolving property is saturated and the volatility of the ink composition is insufficient so that the ink composition tends to flow or blur when it is printed on a printing medium.

In addition to the ester derivative of (poly)ethylene glycol and the oxygen-containing heterocyclic compound, a (poly)alkylene glycol dialkyl ether is also used as a solvent. Thereby, the storage stability, ejecting stability and drying property of the ink composition are further improved.

Different from the ester derivative of (poly)ethylene glycol, the (poly)alkylene glycol dialkyl ether has ether structures at the both end of an ethylene glycol molecule. Therefore, it has specific characteristics such as a lower resin-dissolving property and a lower surface tension than the ester derivatives. Therefore, if the (poly)alkylene glycol dialkyl ether alone is used as a primary solvent, an ink composition would hardly have the above characteristics. However, when the (poly)alkylene glycol dialkyl ether is used as a supplemental solvent to the mixed solvent of the ester derivative of (poly)ethylene glycol and the oxygen-containing heterocyclic compound, It effectively functions as a co-solvent for controlling the resin-dissolving property, surface tension and drying property of the ink composition.

Examples of (poly)alkylene glycol dialkyl ethers include ethylene glycol dialkyl ethers, diethylene glycol dialkyl ethers, triethylene glycol dialkyl ethers, propylene glycol dialkyl ethers, dipropylene glycol dialkyl ether, tripropylene glycol dialkyl ethers, and so on. They may be used singly or as a mixture of two or more of them.

Specific examples of the (poly)alkylene glycol dialkyl ethers include ethylene glycol dibutyl ether, diethylene glycol dimethyl ether, diethylene glycol diethyl ether, diethylene glycol dibutyl ether, propylene glycol dimethyl ether, propylene glycol diethyl ether, propylene glycol dibutyl ether, dipropylene glycol dimethyl ether, dipropylene glycol diethyl ether, etc. These derivatives are preferably used since they have particularly low odor.

In particular, diethylene glycol diethyl ether is preferably used as the solvent of the ink composition, since it has relatively low odor and a low viscosity.

The amount of the (poly)alkylene glycol dialkyl ether to be used is from 5 to 50% by weight, preferably from 10 to 30% z by weight, more preferably from 10 to 25% by weight, based on the whole weight of the ink composition. When the amount of the (poly)alkylene glycol dialkyl ether exceeds 50% by weight, the resin-dissolving property of the ink composition may decrease, the dispersion stability may be deteriorated and the ink composition may be badly ejected. When the amount of the (poly) alkylene glycol dialkyl ether is less than 10% by weight, the drying of the printed ink may tend to delay and also the resin-dissolving property of the ink composition increases so that the pigment particles may tend to agglomerate.

The ink composition of the present invention contains the ester derivative of (poly)ethylene glycol, the oxygen-containing heterocyclic compound and the (poly) alkylene glycol dialkyl ether as the organic solvents. Apart from these three organic solvents, the ink composition of the present invention may optionally contain other general organic solvents such as alcohols, ketones, esters, amines, glycols, glycol ethers, aromatic compounds, etc. Needless to say, the kind and amount of such an optional organic solvent should be selected so that the characteristic properties of the ink composition of the present invention are not impaired.

In particular, most of the ketones, esters and aromatic compounds emit odor when they are used even in a small amount. Therefore, when such a solvent is used, one having a boiling point of at least 170° C. and a flash point of at least 70° C. is preferably used. From the viewpoint of odor and safeness, the amount of an organic solvent having a boiling point of lower than 170° C. is less than 1% by weight, preferably less than 0.5% by weight, more preferably less than 0.1% by weight, based on the whole weight of the ink composition. Most preferably, an organic solvent having a boiling point of lower than 170° C. is not used.

The oil-based pigmented ink composition of the present invention preferably has a flash point of 61 to 100° C., more preferably 65 to 95° C. When an ink composition has a flash point of 61° C. or lower, it is classified into flammable liquids having a high flash point in the case of dangerous materials to be shipped according to international transport-related laws. Therefore, the handling of such ink compositions is difficult because of the limitation of the transport or transfer. Furthermore, such ink composition may carry a lot of risk such as firing in the case of troubles, for example, the leakage of the ink composition. In contrast, when the ink composition has a flash point of 61° C. or higher, such problems can be avoided. An ink composition having a flash point of 100° C. or higher is less preferable, since it is hardly dried, which causes offset.

The oil-based pigmented ink composition of the present invention is characterized in that it contains the specific combination of the organic solvents as described above. As coloring agents contained in the ink composition of the present invention, pigments are used in view of light stability. The pigments include inorganic pigments and organic pigments. The pigments may be modified to increase the dispersibility thereof. Non-limiting examples of commercially available modified pigments include EFKA 6745 and EFKA 6750 (both available from EFKA Additives), SOLSPERS E5000 and SOLSPERSE E22000 (both available from Lubrizol), and so on.

Examples of the inorganic pigment include titanium oxide, Chinese white (zinc flower), zinc oxide, lithopone, iron oxide, aluminum oxide, silicon dioxide, kaolinite, montmorillonite, talc, barium sulfate, calcium carbonate, silica, alumina, cadmium red, red oxide, molybdenum red, chrome vermilion, molybdate orange, chrome yellow, cadmium yellow, yellow iron oxide, chromium oxide, viridian, cobalt green, titanium cobalt green, Paris blue, cobalt chrome green, Armenian blue, ultramarine blue pigment, cobalt blue, cerulean blue, manganese violet, cobalt violet, mica, etc.

Examples of the organic pigments include azo pigments, azomethine pigments, polyazo pigments, phthalocyanine pigments, quinacridone pigments, anthraquinone pigments, indigo pigments, thioindigo pigments, quinophthalone pigments, benzimidazolone pigments, isoindoline pigments, isoindoline pigments, etc. Also, carbon black comprising acidic, neutral or basic carbon may be used. In addition, hollow particles of crosslinked acrylic resins may be used as a pigment.

Examples of pigments contained in cyan ink compositions include C.I. Pigment Blue 1, 2, 3, 15:3, 15:4, 15:34, 16, 22 and 60, etc. In particular, one or more of C.I. Pigment Blue 15:3 and 15:3 are preferably used in view of their good weather resistance and coloring power.

Examples of pigments contained in magenta ink compositions include C.I. Pigment Red 5, 7, 12, 48(Ca), 48(Mn), 57(Ca), 57:1, 112, 122, 123, 168, 184, 202, 209 and 254, C.I. Pigment Violet 19, etc. In particular, one or more of C.I. Pigment Red 122, 202, 209 and 254 and C.I. Pigment Violet 19 are preferably used in view of their good weather resistance and coloring power.

Examples of pigments contained in yellow ink compositions include C.I. Pigment Yellow 1, 2, 3, 12, 13, 14C, 16, 17, 73, 74, 75, 83, 93, 95, 97, 98, 109, 110, 114, 120, 128, 129, 130, 138, 1.39, 147, 150, 151, 154, 155, 180, 185, 213, 214, etc. Among them, C.I. Pigment Yellow 74, 83, 109, 110, 120, 128, 138, 139, 150, 151, 159, 155, 213 and 214 are preferably used singly or as a mixture thereof in view of their good weather resistance.

Examples of pigments contained in black ink compositions include HCF, MCF, RCF, LEF and SCF (available from Mitsubishi Chemical Co., Ltd.), MONARCH and REGAL (available from Cabot, USA), COLOR BLACK, SPECIAL BLACK and PRINTEX (available from Degussa Huls AG), TOKA BLACK (available from TOKAI CARBON Co., Ltd.), RAVEN (available from Columbian Chemical, USA), and the like.

In particular, one or more of HCF X #2650, #2600, #2350 and #2300, MCF #1000, #980, #970 and #960, MCF 88, LFFMA 7, MA 8, MA 11, MA 77 and MA 100 (available from Mitsubishi Chemical Co., Ltd.), and PRINTEX 95, 85, 75, 55 and 45 (available from Degussa Huls AG) are preferably used.

In the oil-based pigmented ink composition of the present invention, polymer are used as a pigment-dispersant and/or a fixing resin. The pigment-dispersant has good affinity with the pigment and stabilizes the dispersion of the pigment. The fixing resin has good adhesion to a substrate and imparts durability to the printed material.

When the pigment-disperstant and/or the fixing resin are adequately selected depending on the kinds of the pigment, organic solvents and printing medium, the ink composition has good effects. Among the polymers, a single polymer may act as a pigment-dispersant and a fixing resin.

The polymer preferably has a solubility in water or ethanol of 3% by weight or less, in particular 1% by weight or less from the viewpoint of water resistance and alcohol resistance of printed materials.

The pigment-dispersant and/or the fixing resin remain on the surface of the substrate after printing with the ink-jet printing system and then they are dried to fix the pigments to the substrate. Therefore, if the polymer is easily soluble in water, the printed material has less water resistance so that the printed parts are washed off with rain, when the printed material is used outdoors. When the printed material is used in the form of a poster, a coating agent or an antistatic agent is often sprayed on the printed surface. Since the coating agent or the antistatic agent mostly contains an alcoholic solvent as a solvent, the printed parts are sagged with the coating agent or the antistatic agent if the polymers are easily soluble in the alcoholic solvent. Compared with this, the polymers having the solubility in water and ethanol in the above range do not suffer from such problems.

As the pigment-dispersant, an ionic or nonionic (low molecular weight) surfactant, or an anionic, cationic or nonionic polymer is used. In view of the dispersion stability of the ink composition and/or the durability such as water resistance and scratch resistance of the printed material, the polymer, in particular, a polymer having a cationic group or an anionic group is preferable.

The pigment-dispersant stabilizes the pigment in the organic solvent through an acid-base interaction between the pigment and the dispersant. Thus, the pigment-dispersant should contain at least one of a cationic group and an anionic group, which function as pigment-absorbing sites, and the kind and amount of the cationic group and the anionic group of the dispersant are selected depending on the kind of the pigment.

Examples of the polymeric pigment-dispersant include SOLSPERSE (available from Lubrizol), DISPER BYK (available from BYK-Chemie), EFKA (available from EFKA Additives), TEXAPHOR (available from Cognis), etc. When these pigment-dispersants are selected according to the kinds of the pigment and/or solvents, the pigment can be well dispersed in the ink composition.

The pigment-dispersants are usually available in the market in the form of solutions. In such a case, the solution contains a low-boiling solvent such as toluene, xylene, ethyl acetate, butyl acetate, methyl ethyl ketone, etc. When the resin solution is used as such in the preparation of the ink composition, the ink composition may have odor originated from such a solvent. Therefore, the low-boiling solvent is removed from the solution of the pigment-dispersant, if necessary, when the solvents may have adverse affects on the properties of the ink composition, for example, odor, safeness, etc. The low-boiling solvent can be removed by any conventional method such as vacuum distillation, reprecipitation, etc. By such removal methods, the content of the low-boiling solvent having a boiling point of lower than 170° C. in the dispersant solution is decreased to 1% by weight or lower, preferably 0.5% by weight or lower, more preferably 0.1% by weight or lower of the dispersant solution. Thereby, the odor of the ink composition can be controlled.

As the fixing resin, at least one resin selected from the group consisting of polyester resins, polyurethane resins and polyvinyl chloride resins is preferably used. These resins have good fixing properties to PVC. The water resistance, dispersion stability, printing properties, etc. can be controlled by selecting the structures and functional groups of the resins. Among them, polyethylene resins, polyurethane resins and vinyl chloride resin are preferable.

Preferable examples of the polyester resin include ELITEL of UNITIKA Co., Ltd. and VYLON of Toyobo Co., Ltd. Preferable examples of the polyurethane resin include VYLON UR of Toyobo Co., Ltd. and NIPPORAN, of Nippon Polyurethane Industry Co., Ltd. Preferable examples of the vinyl chloride resin include SOLBIN of Nissin Chemical Industries, Ltd., SEKISUI PVC-TG and SEKISUI PVC-HA of Sekisui Chemical Co., Ltd., and UCAR Series of DOW CHEMICAL.

The fixing resin preferably has a weight-average molecular weight of 5000 to 100,000, more preferably 5000 to 70,000, most preferably 10,000 to 50,000.

When the weight average molecular weight of the fixing resin is less than 5000, the effect of steric repellence may not be achieved when the resin is adsorbed on the pigment particles in the ink composition so that the storage stability of the ink composition is not improved, the fixing of the pigment to the printing medium may not be increased, and thus the film strength may not be sufficiently attained. When the weight average molecular weight of the fixing resin exceeds 10,000, the effects of the use of the fixing resin is saturated and also the viscosity of the ink composition increases so that the ink composition may not have sufficient flowability.

Herein, the weight average molecular weight means a molecular weight of the resin measured by gel permeation chromatography and calibrated with standard samples of polystyrene.

When the polymeric a pigment-dispersant is present in the ink composition of the present invention, the amount of the pigment-dispersant may depend on the kinds of the pigment and solvent used for dispersing the pigment, the dispersing conditions, etc., and is usually from 5 to 150% by weight, in particular, from 40 to 120% by weight when the organic pigment is used, or from 5 to 60% by weight when the inorganic pigment is used, based on the weight of the pigment.

When the polymeric fixing resin is used, the amount of the fixing resin may depend on the kind and molecular weight of the resin, the kinds of the pigment and solvents, and is usually from 5 to 200% by weight based on the weight of the pigment. In another way, the amount of the fixing resin is preferably from 0.5 to 5.0% by weight based on the whole weight of the ink composition.

Besides the polyester resins, polyurethane resins or vinyl chloride resins, acrylic resins, ketone resins, phenol resins, polyamide resins, rosin resins, cellulose resins, etc. may be used. When these resins are used, their molecular weight, solubility and amount are preferably within the ranges described above.

The ink composition of the present invention may be prepared by premixing and dispersing the pigment, the polymer (pigment-dispersant) and a part of the ester derivative of (poly) ethylene glycol as a solvent and then, to the dispersion, adding the polymer (e.g. the fixing resin), the rest of the solvents, that is, the remaining ester derivative of (poly)ethylene glycol, the (poly) alkylene glycol dialkyl ether and the oxygen-containing heterocyclic compound followed by mixing and dispersing.

To prepare the above dispersion, the pigments, the resins and the solvents are well stirred and mixed using a barrel-driving type mills (e.g. ball mill, centrifugal mill, planetary mill, etc.), high speed rotation mills (e.g. sand mill, etc.), medium-agitation mills (e.g. agitated vessel mill, etc.), simple dispersing equipment (e.g. disper, etc.), and the like.

Further, to the above dispersion, the resins and the solvents may be post-added and then the dispersion may additionally be uniformly mixed with a simple stirrer such as a three-one motor, a magnetic stirrer, a disper, a homogenizer, etc. A mixer such as a line-mixer may be used to mix them.

Besides the pigment, polymers and organic solvents, the ink composition of the present invention may optionally contain conventionally used additives such as surfactants, surface-modifiers, leveling agents, defoaming agents, antioxidants, pH regulators, charging agents, disinfectants, preservatives, deodorants, charge-adjusters, wetting agents, anti-skinning agents, UV-ray absorbers, perfumes, pigment derivatives, etc.

The oil-based pigmented ink of the present invention, in particular, one for ink-jet printing systems, has a surface tension of 20 to 40 mN/m (at 25° C.) and a viscosity of 2 to 15 cp (at 25° C.), preferably 3 to 13 cp.

When the ink composition having the surface tension and viscosity in the above ranges is used as an ink composition for the ink-jet printing system, it has good jetting properties so that the flying track of an ink drop is not curved or swerved, and the printed characters or images are less blurred, when the ink composition is printed on the substrate.

In the oil-based pigmented ink composition of the present invention, the pigment preferably has a dispersion average particle size of 20 to 250 nm, more preferably 50 to 200 nm, most preferably 70 to 160 nm. When the dispersion average particle size is less than 20 nm, the particles are too small so that the printed material may lose the durability. When the dispersion average particle size exceeds 200 nm, the fineness of the printed material may deteriorate.

With the oil-based pigmented ink composition of the present invention, the surface tension and viscosity at 25° C. and the dispersion average particle size of the pigment particles can be adjusted in the above respective ranges by suitably selecting the kinds and amounts of the components of the ink composition, since the above specific compounds are used as the organic solvents.

### EXAMPLES

Hereinafter, the present invention will be illustrated by the following examples, in which “parts” means “parts by weight” unless otherwise indicated.

### Example 1

A pigment, a resin and a solvent were mixed in the amounts described below and dispersed in a Disper (Primix Corporation) at 2000 rpm for 30 minutes. Thereafter, the dispersion was circulated in a bead mill filled with zirconia beads having a diameter of 0.3 mm (a residence time of 30 minutes) to obtain a pigment dispersion.

20 parts of a pigment: β-copper phthalocyanine blue (“FASTOGEN BLUE 5430SD” available from Dainippon Ink and Chemicals Incorporated)

40 parts of a resin (pigment-dispersant): an amine-based polymer dispersant (“BYK 168” available from BYK-Chemie)

40 parts of a solvent: ethylene glycol mono-n-butyl ether monomethyl ester (available from Kyowa Hakko Chemical Co., Ltd.; flash flint: 87.5° C.)

From the dispersion obtained in the above, 15 parts were weighed. To the dispersion, the following materials were successively charged while stirring with a Disper at 1500 rpm, and after charging all the materials, the mixture was stirred for 30 minutes and then suction filtrated through a glass filter (available from KIRIYAMA. GLASS WORKS Co., Ltd.) to obtain Ink Composition A.

41 parts of ethylene glycol mono-n-butyl ether monomethyl ester

20 parts of γ-butyrolactone (available from ISP; flash point: 93° C.)

20 parts of dipropylene glycol dimethyl ether (available from Dow Chemical; flash point: 60° C.)

4.0 parts of a resin: vinyl chloride-vinyl acetate copolymer (“VYHD” available from Dow Chemical; weight average molecular weight: 22,000)

### Example 2

Fifteen parts of the dispersion obtained in Example 1 were weighed. To the dispersion, the following materials were successively charged while stirring with a Disper at 1500 rpm, and after charging all the materials, the mixture was stirred for 30 minutes and then suction filtrated through a glass filter to obtain Ink Composition B.

36 parts of ethylene glycol mono-n-butyl ether monomethyl ester

25 parts of γ-butyrolactone

20 parts of diethylene glycol diethyl ether (available from Nippon Nyukazai Co., Ltd.; flash point: 82° C.)

4 parts of a resin: vinyl chloride-vinyl acetate copolymer (“VYHH” available from Dow Chemical; weight average molecular weight: 27,000)

### Example 3

Fifteen parts of the dispersion obtained in Example 1 were weighed. To the dispersion, the following materials were successively charged while stirring with a Disper at 1500 rpm, and after charging all the materials, the mixture was stirred for 30 minutes and then suction filtrated through a glass filter to obtain Ink Composition C.

46 parts of ethylene glycol mono-n-butyl ether monomethyl ester

20 parts of ε-caprolactone (available from Wako Pure Chemical Industries, Limited; flash point: 109° C.)

15 parts of diethylene glycol diethyl ether

4 parts of a resin: vinyl chloride-vinyl acetate copolymer (“Solbin C5R” available from Nissin Chemical Industry Co., Ltd.; weight average molecular weight: 27,000)

### Example 4

A pigment, a resin and a solvent were mixed in the amounts described below and dispersed in a Disper (Primix Corporation) at 2000 rpm for 30 minutes. Thereafter, the dispersion was circulated in a bead mill filled with zirconia beads having a diameter of 0.3 mm (a residence time of 30 minutes) to obtain a pigment dispersion.

20 parts of a pigment: a yellow pigment (“E4GN-GT” available from Lanxess)

16 parts of a resin (pigment-dispersant): a polyester-based dispersant (“SOLSPERSE 3000” available from Lubrizol)

64 parts of a solvent: diethylene glycol monoethyl ether monomethyl ester (available from Kyowa Hakko Chemical Co., Ltd.; flash point: 105° C.)

From the dispersion obtained in the above, 15 parts were weighed. To the dispersion, the following materials were successively charged while stirring with a Disper at 1500 rpm, and after charging all the materials, the mixture was stirred for 30 minutes and then suction filtrated through a glass filter to obtain Ink Composition D.

32 parts of diethylene glycol monoethyl ether monomethyl ester

20 parts of ethylene glycol mono-n-butyl ether monomethyl ester

15 parts of γ-butyrolactone (available from ISP; flash point: 93° C.)-15 parts of dipropylene glycol dimethyl ether (available from Dow Chemical; flash point: 60° C.)

3 parts of a resin: vinyl chloride-vinyl acetate copolymer (“VAGH” available from Dow Chemical; weight average molecular weight: 27,000)

### Example 5

Fifteen parts of the dispersion obtained in Example 4 were weighed. To the dispersion, the following materials were successively charged while stirring with a Disper at 1500 rpm, and after charging all the materials, the mixture was stirred for 30 minutes and then suction filtrated through a glass filter to obtain Ink Composition E.

47 parts of diethylene glycol monoethyl ether monomethyl ester

15 parts of ε-caprolactone (available from Wako Pure Chemical Industries, Limited; flash point: 109° C.)

20 parts of diethylene glycol diethyl ether

3 parts of a resin: vinyl chloride-vinyl acetate copolymer (“Solbin C5” available from Nissin Chemical Industry Co., Ltd.; weight average molecular weight: 30,000)

### Example 6

Fifteen parts of the dispersion obtained in Example 4 were weighed. To the dispersion, the following materials were successively charged while stirring with a Disper at 1500 rpm, and after charging all the materials, the mixture was stirred for 30 minutes and then suction filtrated through a glass filter to obtain Ink Composition F.

52 parts of diethylene glycol monoethyl ether monomethyl ester

5 parts of ε-caprolactone (available from Wako Pure Chemical Industries, Limited; flash point: 109° C.)

25 parts of diethylene glycol diethyl ether

3 parts of a resin: vinyl chloride-vinyl acetate copolymer (“Solbin C5” available from Nissin Chemical Industry Co., Ltd.; weight average molecular weight: 30,000)

### Example 7

A pigment, a resin and a solvent were mixed in the amounts described below and dispersed in a Disper (Primix Corporation) at 2000 rpm for 30 minutes. Thereafter, the dispersion Was circulated in a bead mill filled with zirconia beads having a diameter of 0.3 mm (a residence time of 30 minutes) to obtain a pigment dispersion.

20 parts of a pigment: carbon black (“MA 8” available from Mitsubishi Chemical Corporation)

16 parts of a resin (pigment-dispersant): a polyester-based polymer dispersant (“SOLSPERSE 32000”)

64 parts of a solvent: ethylene glycol dimethyl ester (available from Wako Pure Chemical Industries, Limited; flash point: 96° C.)

From the dispersion obtained in the above, 15 parts were weighed. To the dispersion, the following materials were successively charged while stirring with a Disper at 1500 rpm, and after charging all the materials, the mixture was stirred for 30 minutes and then suction filtrated through a glass filter (available from KIRIYAMA CLASS WORKS Co., Ltd.) to obtain Ink Composition G.

32 parts of ethylene glycol dimethyl ester

10 parts of ethylene glycol mono-n-butyl ether monomethyl ester

20 parts γ-butyrolactone

20 parts of dipropylene glycol dimethyl ether (available from Dow Chemical; flash point: 60° C.)

3 parts of a resin: vinyl chloride-vinyl acetate copolymer (“VAGF” available from Dow Chemical; weight average molecular weight: 33,000)

### Example 8

Fifteen parts of the dispersion obtained in Example 7 were weighed. To the dispersion, the following materials were successively charged while stirring with a Disper at 1500 rpm, and after charging all the materials, the mixture was stirred for 30 minutes and then suction filtrated through a glass filter (available from KIRIYAMA GLASS WORKS Co., Ltd.) to obtain Ink Composition H.

26.5 carts of ethylene glycol dimethyl ester

20 parts of ethylene glycol mono-n-butyl ether monomethyl ester

15 parts of ε-caprolactone (available from Wako Pure Chemical Industries, Limited; flash point: 109° C.)

20 parts of dipropylene glycol dimethyl ether

3.5 parts of a resin: vinyl chloride-vinyl acetate copolymer (“Solbin C5,” available from Nissin Chemical Industry Co., Ltd.; weight average molecular weight: 31,000)

### Example 9

Fifteen parts of the dispersion obtained in Example 7 were weighed. To the dispersion, the following materials were successively charged while stirring with a Disper at 1500 rpm, and after charging all the materials, the mixture was stirred for 30 minutes and then suction filtrated through a glass filter to obtain Ink. Composition I.

41.5 parts of ethylene glycol dimethyl ester

20 parts of γ-valerolactone (available from Nakalai Tesque, Inc.; flash point: 81° C.)

20 parts of diethylene glycol diethyl ether

3.5 parts of a resin: vinyl chloride-vinyl acetate copolymer (“Solbin C5” available from Nissin Chemical Industry Co., Ltd.; weight average molecular weight: 31,000)

### Example 10

Fifteen parts of the dispersion obtained in Example 7 were weighed. To the dispersion, the following materials were successively charged while stirring with a Disper at 1500 rpm, and after charging all the materials, the mixture was stirred or 30 minutes and then suction filtrated through a glass filter to obtain Ink Composition J.

70.5 parts of ethylene glycol dimethyl ester

5 parts of γ-valerolactone (available from Nakalai Tesque, Inc.; flash point: 81° C.)

6 parts of diethylene glycol diethyl ether

3.5 parts of a resin: vinyl chloride-vinyl acetate copolymer

(“Solbin C5” available from Nissin Chemical Industry Co., Ltd.; weight average molecular weight: 31,000)

### Example 11

Fifteen parts of the dispersion obtained in Example 7 were weighed. To the dispersion, the following materials were successively charged while stirring with a Disper at 1500 rpm, and after charging all the materials, the mixture was stirred for 30 minutes and then suction filtrated through a glass filter (available from KIRIYAMA GLASS WORKS Co., Ltd.) to obtain Ink Composition K.

6.5 parts of ethylene glycol dimethyl ester

12 parts of ethylene glycol mono-n-butyl ether monomethyl ester

15 parts of γ-butyrolactone

48 parts of dipropylene glycol dimethyl ether

3.5 parts of a resin: vinyl chloride-vinyl acetate copolymer (“Solbin C5” available from Nissin Chemical Industry Co., Ltd.; weight average molecular weight: 31,000)

### Comparative Example 1

Ink composition containing no oxygen-containing heterocyclic compound:

Fifteen parts of the dispersion obtained in Example 1 were weighed. To the dispersion, the following materials were successively charged while stirring with a Disper at 1500 rpm, and after charging all the materials, the mixture was stirred for 30 minutes and then suction filtrated through a glass filter to obtain Ink Composition L.

81 parts of ethylene glycol mono-n-butyl ether monomethyl ester

4 parts of a resin: vinyl chloride-vinyl acetate copolymer (“VYHD” available from Dow Chemical; weight average molecular weight: 22,000)

### Comparative Example 2

Ink composition containing no oxygen-containing heterocyclic compound:

Fifteen parts of the dispersion obtained in Example 1 were weighed. To the dispersion, the following materials were successively charged while stirring with a Disper at 1500 rpm, and after charging all the materials, the mixture was stirred for 30 minutes and then suction filtrated through a glass filter to obtain Ink Composition M.

66.5 parts of ethylene glycol mono-n-butyl ether monomethyl ester

15 parts of dipropylene glycol dimethyl ether

3.5 parts of a resin: vinyl chloride-vinyl acetate copolymer (“VYHH” available from Dow Chemical; weight average molecular weight: 27,000)

### Comparative Example 3

Ink composition comprising no ester derivative of (poly)ethylene glycol as a primary solvent:

A pigment, a resin and a solvent were mixed in the amounts described below and dispersed in a Disper (Primix Corporation) at 2000 rpm for 30 minutes. Thereafter, the dispersion was circulated in a bead mill filled with zirconia beads having a diameter of 0.3 mm (a residence time of 30 minutes) to obtain a pigment dispersion.

20 parts of a pigment: a yellow pigment (“E4GN-GT” available from Lanxess)

16 parts of a resin (pigment-dispersant): a polyester-based polymer dispersant (“SOLSPERSE 33000” available from Lubrizol)

64 parts of a solvent: diethylene glycol diethyl ether

From the dispersion obtained in the above, 15 parts were weighed. To the dispersion, the following materials were successively charged while stirring with a Disper at 1500 rpm, and after charging all the materials, the mixture was stirred for 30 minutes and then suction filtrated through a glass filter to obtain Ink Composition N.

61 parts of diethylene glycol diethyl ether

20 parts of γ-butyrolactone (available from ISP; flash point: 93° C.)

4 parts of a resin: vinyl chloride-vinyl acetate copolymer (“VYHH” available from Dow Chemical; weight average molecular weight: 27,000)

### Comparative Example 4

Ink composition comprising no (poly)alkylene glycol dialkyl ether:

A pigment, a resin and a solvent were mixed in the amounts described below and dispersed in a Disper (Primix Corporation) at 2000 rpm for 30 minutes. Thereafter, the dispersion was circulated in a bead mill filled with zirconia beads having a diameter of 0.3 mm (a residence time of 30 minutes) to obtain a pigment dispersion.

20 parts of a pigment: a yellow pigment (“E4GN-GT” available from Lanxess)

16 parts of a resin (pigment-dispersant): a polyester-based polymer dispersant (“SOLSPERSE 33000” available from Lubrizol)

64 parts of a solvent: ethylene glycol mono-n-butyl ether monomethyl ester

From the dispersion obtained in the above, 15 parts were weighed. To the dispersion, the following materials were successively charged while stirring with a Disper at 1500 rpm, and after charging all the materials, the mixture was stirred for 30 minutes and then suction filtrated through a glass filter to obtain Ink Composition O.

61 parts of ethylene glycol mono-n-butyl ether monomethyl ester

20 parts of γ-butyrolactone

4 parts of a resin: vinyl chloride-vinyl acetate copolymer (“VYHD” available from Dow Chemical; weight average molecular weight: 22,000)

### Comparative Example 5

Ink composition comprising nitrogen-containing heterocyclic compound:

Fifteen parts of the dispersion obtained in Example 4 were weighed. To the dispersion, the following materials were successively charged while stirring with a Disper at 1500 rpm, and after charging all the materials, the mixture was stirred for 30 minutes and then suction filtrated through a glass filter to obtain Ink composition P.

41 parts of ethylene glycol mono-n-butyl ether monomethyl ester

20 parts of N-methyl-2-pyrrolidone (available from ISP; flash point: 93° C.)

20 parts of dipropylene glycol dimethyl ether

4 parts of a resin: vinyl chloride-vinyl acetate copolymer (“VYHH” available from Dow Chemical; weight average molecular weight: 27,000)

### Comparative Example 6

Ink composition containing more than 30% by weight of oxygen-containing heterocyclic compound:

Fifteen parts of the dispersion obtained in Example 7 were weighed. To the dispersion, the following materials were successively charged while stirring with a Disper at 1500 rpm, and after charging all the materials, the mixture was stirred for 30 minutes and then suction filtrated through a glass filter (available from KIRIYAMA GLASS WORKS Co., Ltd.) to obtain Ink Composition Q.

6.5 parts of ethylene glycol dimethyl ester

22 parts of ethylene glycol mono-n-butyl ether monomethyl ester

38 parts of γ-butyrolactone

15 parts of dipropylene glycol dimethyl ether

3.5 parts of a resin: vinyl chloride-vinyl acetate copolymer (“Solbin C5” available from Nissin Chemical Industry Co., Ltd.; weight average molecular weight: 31,000)

With Ink Compositions A to K prepared in Examples 1-11, Ink Compositions L to Q prepared in Comparative Examples 1-6, a viscosity, a surface tension, a dispersion average particle size and a flash point were measured by the methods described below. The results are shown in Table 1.

Viscosity: A viscosity of an ink composition was measured using a R100 viscometer (available from TOKI SANGYO Co., Ltd.) at 25° C. and a cone rotation speed of 20 rpm.

Surface tension: A surface tension of an ink composition was measured using a full-automatic balance type electrotensiometer ESB-V (available from KYOWA SCIENCE Co., Ltd.) at an ink temperature of 25° C.

Dispersion average particle size: A dispersion average particle size of pigment particles was measured using a particle size analyzer N4-PLUS (a laser Doppler particle size analyzer available from Coulter). In this measurement, an organic solvent which was contained in a largest amount in each ink composition was used as a diluent.

Flash point: A flash point of an ink composition was measured using a TAG sealed flash point tester.

In Table 1, with regard to the kind of each ink composition, it is simply expressed as “Ink Composition A”, for example, with omitting a “oil-based pigmented”.

TABLE 1

| | | | | Dispersion | |
|---|---|---|---|---|---|
| | | | | average | |
| | | | Surface | particle | Flash |
| | | Viscosity | tension | size | point |
| | Ink Composition | (cp) | (mN/m) | (nm) | (° C.) |
| Ex. 1 | Ink Composition A | 4.4 | 29.0 | 110 | 73 |
| Ex. 2 | Ink Composition B | 4.6 | 29.4 | 113 | 87 |
| Ex. 3 | Ink Composition C | 4.8 | 29.1 | 118 | 89 |
| Ex. 4 | Ink Composition D | 4.5 | 29.1 | 118 | 89 |
| Ex. 5 | Ink Composition E | 5.8 | 29.6 | 160 | 82 |
| Ex. 6 | Ink Composition F | 6.0 | 29.5 | 165 | 88 |
| Ex. 7 | Ink Composition G | 5.2 | 29.5 | 95 | 92 |
| Ex. 8 | Ink Composition H | 5.1 | 29.3 | 99 | 87 |
| Ex. 9 | Ink Composition I | 5.2 | 29.3 | 93 | 88 |
| Ex. 10 | Ink Composition J | 5.9 | 29.7 | 98 | 94 |
| Ex. 11 | Ink Composition K | 4.6 | 28.8 | 93 | 64 |
| C. Ex. 1 | Ink Composition L | 4.1 | 28.6 | 110 | 85 |
| C. Ex. 2 | Ink Composition M | 3.6 | 28.2 | 115 | 80 |
| C. Ex. 3 | Ink Composition N | 4.8 | 29.0 | 160 | 84 |
| C. Ex. 4 | Ink Composition O | 4.0 | 29.1 | 165 | 64 |
| C. Ex. 5 | Ink Composition P | 5.0 | 29.5 | 166 | 78 |
| C. Ex. 6 | Ink Composition Q | 5.3 | 29.8 | 172 | 84 |

Next, with Ink Compositions A to K prepared in Examples 1-11 and Ink Compositions L to Q prepared in Comparative Examples 1-6, a drying property, a fixing property, alcohol resistance and storage stability were evaluated by the methods described below. The results are shown in Table 2.

In Table 2, with regard to the kind of each ink composition, it is simply expressed as “Ink Composition A”, for example, with omitting “oil-based pigmented”.

Drying property: An ink composition was coated on a glossy PVC sheet (P-224RW available from LINTEC Corporation) with a No. 8 wire bar (available from TOYO SEIKI KOGYO Co., Ltd.) in a temperature-controlled room at 25° C. and 30% RH, and its drying property was evaluated according to the following criteria: A: When the coated composition is touched with a finger, the coated composition does not adhere to the finger within one minute drying; B: When the coated composition is touched with a finger, the coated composition does not adhere to the finger within 5 minutes drying; C: When the coated composition is touched with a finger, the coated composition still adheres to the finger after 5 minutes drying.

Fixing property: An ink composition was coated on a glossy PVC sheet (P-224RW available from LINTEC Corporation) with a No. 8 wire bar (available from TOYO SEIKI KOGYO Co., Ltd.) in a temperature-controlled room at 25° C. and 30% RH. After being kept standing for 24 hours, a sliding test was carried out using a sliding tester (HEIDON-14DR manufactured by HEIDON) with pressing a rubber eraser having a diameter of 7 mm (XZERST available from PENTEL Co., Ltd.) as a sliding member to the coated surface of the PVC sheet.

The sliding test was done at a rate of 1000 mm/min., a sliding magnitude of 20 mm and the sliding number of 5 with loading a weight of 1000 g. The fixing property was evaluated according to the following criteria: A: the coated layer is not removed at all; B: The color is partly removed; C: The coated layer is removed and the sheet surface is exposed.

Alcohol resistance 1: An ink composition was coated on a glossy PVC sheet (P-224RW available from LINTEC Corporation) with a No. 8 wire bar (available from TOYO SEIKI KOGYO Co., Ltd.) in a temperature-controlled room at 25° C. and 30% RH. After being kept standing for 24 hours, a sliding test was carried out using a sliding tester (HEIDON-14DR manufactured by HEIDON) with pressing a cotton bud transfused with a mixed solvent of water and ethanol (weight ratio=5:5) to the coated surface of the PVC sheet.

The sliding test was done at a rate of 5000 mm/min., a sliding magnitude of 20 mm and the sliding number of 100 with loading a weight of 300 g. The alcohol resistance was evaluated according to the following criteria: A: the coated layer is not removed at all; B: The color is partly removed; C: The coated layer is removed and the sheet surface is exposed.

Alcohol resistance 2: With the ink compositions which were ranked “A” in the test of Alcohol Resistance 1 above, the same sliding test as in alcohol Resistance 1 was carried out except that a mixed solvent of water and ethanol or pure ethanol having a weight ratio of 4:6 to 0:10 was used, and the ethanol resistance was evaluated according to a mixing ratio of water to alcohol with which when the coated layer was removed and the substrate sheet was exposed. For example, when the coated layer was removed with a mixed solvent having a water to ethanol ratio of 3:7, it was ranked “7”. When the coated layer was not removed with a mixed solvent having a water to ethanol ratio of 0:10, i.e., pure ethanol, it was ranked “Pass”.

Storage stability: Forty cubic centimeter (40 cc) of an ink composition was charged in a sealable glass bottle (50 cc) and kept in a temperature-controlled room at 60° C. for 30 days. Thereafter, a viscosity and a dispersion average particle size of the ink composition were measured. The storage stability was evaluated according to the following criteria: A: The percentage change of the viscosity and dispersion average particle size before and after the storage is less than 5%; B: the percentage change of the viscosity and dispersion average particle size before and after the storage is between 5% and 10%; C: the percentage change of the viscosity and dispersion average particle size before and

after the storage exceeds 10%.

TABLE 2

| | | | | Alcohol | Alcohol | |
|---|---|---|---|---|---|---|
| | Ink | | | resist- | resist- | |
| | Composi- | Drying | Fixing | ance | ance | Storage |
| | tion | property | property | 1 | 2 | stability |
| Ex. 1 | A | A | A | A | 10 | A |
| Ex. 2 | B | A | A | A | Pass | A |
| Ex. 3 | C | A | A | A | 10 | A |
| Ex. 4 | D | A | A | A | 10 | A |
| Ex. 5 | E | A | A | A | 7 | A |
| Ex. 6 | F | A | A | A | 6 | A |
| Ex. 7 | G | A | A | A | 10 | A |
| Ex. 8 | H | A | A | A | 7 | A |
| Ex. 9 | I | A | A | A | 10 | A |
| Ex. 10 | J | B | A | A | 6 | A |
| Ex. 11 | K | A | A | A | 7 | B |
| C. Ex. 1 | L | C | C | C | — | B |
| C. Ex. 2 | M | C | C | C | — | A |
| C. Ex. 3 | N | A | A | A | 10 | C |
| C. Ex. 4 | O | B | A | A | 10 | C |
| C. Ex. 5 | P | B | A | A | 10 | C |
| C. Ex. 6 | Q | C | A | A | Pass | C |

As can be seen from the results in Table 2, Ink Compositions A, to I of Examples 1 to 9, which contained the ester derivative of (poly)ethylene glycol, the (poly)alkylene glycol dialkyl ether and the oxygen-containing heterocyclic compound according to the present invention had excellent drying and fixing properties and alcohol resistance, and had no problem in printability to polyvinyl chloride substrates and also good storage stability. That is, Ink Compositions A to I are excellent in all evaluated properties.

In addition, in the test of Alcohol Resistance 2, Ink Compositions A to D, G and I of Examples 1 to 4, 7 and 9, respectively, which contained 20 to 30% by weight of the oxygen-containing heterocyclic compound, the coated layers were wiped out only with pure ethanol or they were not wiped out with pure ethanol. Thus, those Ink Compositions had far excellent alcohol resistance.

Ink Composition J of Example 10 containing a relatively large amount of the ester derivative of (poly)ethylene glycol had a slightly low drying property, but it was practically acceptable. Ink Composition K of Example 11 containing a relatively large amount of (poly)alkylene glycol dialkyl ether had slightly inferior storage stability, but it was practically acceptable.

In contrast, Ink Compositions L and M of Comparative Examples 1 and 2, which contained no oxygen-containing heterocyclic compound, had low drying properties and less fixing properties to the polyvinyl chloride substrate. Thus, they might cause some problems when they are used in a printer.

Ink Composition N of Comparative Example 3 contained no ester derivative of (poly)ethylene glycol but contained the nitrogen-containing heterocyclic compound. Thus, this Ink Composition had no problem in the fixing property to the polyvinyl chloride substrate, but had poor dispersion stability and thus low storage stability. Therefore, Ink Composition N might cause agglomeration or precipitation in the case of long-term storage.

Also, Ink Composition O of Comparative Example 4 contained no (poly)alkylene glycol dialkyl ether but contained the oxygen-containing heterocyclic compound. Thus, this Ink Composition had no problem in the fixing property to the polyvinyl chloride substrate, but had a low drying property so that it might cause blur when it is printed. In addition, Ink Composition O had inferior storage stability.

Ink Composition P containing the nitrogen-containing heterocyclic compound in place of the oxygen-containing heterocyclic compound had a satisfactory fixing property to the polyvinyl chloride substrate, but it had a slightly low drying property and a high dissolvability, so that it easily agglomerated and thus its storage stability was unsatisfactory.

Ink Composition Q of Comparative Example 6 contained a large amount of the oxygen-containing heterocyclic compound. Thus, it had satisfactory fixing property and alcohol resistance, but it had a poor drying property and a high dissolvability, so that it easily agglomerated and thus its storage stability was unsatisfactory.

What is claimed is:

1. An oil-based pigmented ink composition comprising a pigment, a polymer and an organic solvent, Wherein the organic solvent contains 20 to 85% by weight of an ester derivative of mono- or polyethylene glycol having a flash point of 50 to 120° C. and a boiling point of 150 to 250° C., 5 to 50% by weight of a mono- or polyalkylene glycol dialkyl ether and 1 to 30% by weight of an oxygen-containing heterocyclic compound, each based on the whole weight of the ink composition.

2. The oil-based pigmented ink composition according to claim 1, wherein said ester derivative of mono- or polyethylene glycol is a mono- or polyethylene glycol monoalkyl ether monoalkyl ester or a mono- or polyethylene glycol dialkyl ester.

3. The oil-based pigmented ink composition according to claim 1, wherein said oxygen-containing heterocyclic compound has a lactone structure.

4. The oil-based pigmented ink composition according to claim 1, wherein said polymer is at least one polymer selected from the group consisting of acrylic resins, polyester resins, polyurethane resins and polyvinyl chloride resins.

5. The oil-based pigmented ink composition according to claim 4, wherein said polymer has a solubility in water or ethanol of 3% by weight or less at 25° C.

6. The oil-based pigmented ink composition according to claim 4 or 5, wherein said polymer has a weight average molecular weight of 5000 to 100,000.

7. The oil-based pigmented ink composition according to any one of claims 1 to 6, which has a flash point of 61 to 100° C.

8. The oil-based pigmented ink composition according to any one of claims 1 to 7, which has a viscosity of 2 to 15 cp at 25° C., a surface tension of 20 to 40 mN/m at 25° C. and a dispersion average particle size of 20 to 200 nm.

9. The oil-based pigmented ink composition according to any one of claims 1 to 8, which contains 20 to 30% by weight of said oxygen-containing heterocyclic compound.
